(19) United States
(12) Patent Application Publication
(10) Pub. No.: US 2023/0260306 A1
(43) Pub. Date: Aug. 17, 2023

(54) Method and Apparatus for Recognizing Document Image, Storage Medium and Electronic Device

(71) Applicant: Beijing Baidu Netcom Science Technology Co., Ltd., Beijing (CN)

(72) Inventors: Yuechen YU, Beijing (CN); Chengquan ZHANG, Beijing (CN); Kun YAO, Beijing (CN)

(73) Assignee: Beijing Baidu Netcom Science Technology Co., Ltd., Beijing (CN)

(21) Appl. No.: 17/884,264

(22) Filed: Aug. 9, 2022

(30) Foreign Application Priority Data
Feb. 16, 2022 (CN) 202210143148.5

(51) Int. Cl. G06V 30/413; G06V 30/414; G06V 30/416; G06V 30/18

(52) U.S. Cl. CPC G06V 30/413; G06V 30/414; G06V 30/416; G06V 30/18143

(57) ABSTRACT

A method and an apparatus is provided for recognizing a document image, a storage medium and an electronic device, relates to the technical field of artificial intelligent recognition, particularly relates to the technical fields of deep learning and computer vision. The method includes that a document image to be recognized is transformed into an image feature map, where the document image at least includes at least one text box and text information including multiple characters; a first recognition content of the document image to be recognized is predicted based on the image feature map, the multiple characters and the text box; the document image to be recognized is recognized based on an optical character recognition algorithm to obtain a second recognition content; and the first recognition content is matched with the second recognition content to obtain a target recognition content.

### CROSS-REFERENCE TO RELATED APPLICATIONS

The present disclosure claims priority of Chinese Patent Application No. 202210143148.5, filed to China Patent Office on Feb. 16, 2022. Contents of the present disclosure are hereby incorporated by reference in entirety of the Chinese Patent Application.

### TECHNICAL FIELD

The present disclosure relates to the technical field of artificial intelligent recognition, particularly relates to the technical fields of deep learning and computer vision, may be applied to image processing and optical character recognition (OCR) scenes, and in particular to relate to a method and an apparatus for recognizing a document image, a storage medium and an electronic device.

### BACKGROUND OF THE INVENTION

A method for recognizing a document image in the related art is mainly achieved through optical character recognition (OCR), with complex image processing procedures. In addition, it is low in recognition accuracy and time-consuming to recognize document images having poor quality or scanned documents with noise (that is, document images or scanned documents having low contrast, uneven distribution of light and shade, blurred background, etc.) through this method.

No effective solution has been provided yet at present to solve the problems.

### SUMMARY OF THE INVENTION

At least some embodiments of the present disclosure provide a method and an apparatus for recognizing a document image, a storage medium and an electronic device.

An embodiment of the present disclosure provides a method for recognizing a document image. The method includes: transforming a document image to be recognized into an image feature map, where the document image at least includes: at least one text box and text information including multiple characters; predicting, based on the image feature map, the multiple characters and the text box, a first recognition content of the document image to be recognized; recognizing, based on an optical character recognition algorithm, the document image to be recognized to obtain a second recognition content; and matching the first recognition content with the second recognition content to obtain a target recognition content.

Another embodiment of the present disclosure provides an apparatus for recognizing a document image. The apparatus includes: a transformation module configured to transform a document image to be recognized into an image feature map, where the document image at least includes: at least one text box and text information including multiple characters; a first prediction module configured to predict, based on the image feature map, the multiple characters and the text box, a first recognition content of the document image to be recognized; a second prediction module configured to recognize, based on an optical character recognition algorithm, the document image to be recognized to obtain a second recognition content; a matching module configured to match the first recognition content with the second recognition content to obtain a target recognition content.

Another embodiment of the present disclosure provides an electronic device. The electronic device includes: at least one processor; and a memory communicatively connected with the at least one processor, where the memory is configured to store at least one instruction executable by the at least one processor, and the at least one instruction enables the at least one processor to execute any method for recognizing the document image described above when being executed by the at least one processor.

Another embodiment of the present disclosure provides a non-transitory computer readable storage medium storing at least one computer instruction, where the at least one computer instruction is configured to enable a computer to execute any method for recognizing the document image described above.

Another embodiment of the present disclosure provides a computer program product. The product includes a computer program, where the computer program implements any method for recognizing the document image described above when being executed by a processor.

Another embodiment of the present disclosure provides a product for recognizing a document image. The product includes: the electronic device described above.

In the embodiments of the present disclosure, the document image to be recognized is transformed into the image feature map, where the document image at least includes: the at least one text box and the text information including the multiple characters; based on the image feature map, the multiple characters and the text box, the first recognition content of the document image to be recognized is predicted; the optical character recognition algorithm is used for recognizing the document image to be recognized to obtain the second recognition content; and the first recognition content is matched with the second recognition content to obtain the target recognition content. Content information in the document image may be accurately recognized, recognition accuracy and efficiency of the document image may be improved, and a computation amount of an image recognition algorithm may be decreased, such that technical problems that it is low in recognition accuracy and large in computation amount of an algorithm to recognize a document image having poor quality through the method for recognizing a document image in the related art are further solved.

It should be understood that the content described in this section is neither intended to limit the key or important features of the embodiments of the present disclosure, nor intended to limit the scope of the present disclosure. Other features of the present disclosure will be easily understood through the following description.

### BRIEF DESCRIPTION OF THE SEVERAL VIEWS OF THE DRAWINGS

Accompanying drawings are used for a better understanding of the solution, and do not limit the present disclosure. In the drawings:

FIG. 1 is a flow diagram of a method for recognizing a document image according to a first embodiment of the present disclosure.

FIG. 2 is a flow diagram of an optional method for recognizing a document image according to a first embodiment of the present disclosure.

FIG. 3 is a flow diagram of another optional method for recognizing a document image according to a first embodiment of the present disclosure.

FIG. 4 is a flow diagram of yet another optional method for recognizing a document image according to a first embodiment of the present disclosure.

FIG. 5 is a flow diagram of still another optional method for recognizing a document image according to a first embodiment of the present disclosure.

FIG. 6 is a structural schematic diagram of an apparatus for recognizing a document image according to a second embodiment of the present disclosure.

FIG. 7 is a block diagram of an electronic device for implementing a method for recognizing a document image according to an embodiment of the present disclosure.

### DETAILED DESCRIPTION OF THE INVENTION

Exemplary embodiments of the present disclosure are described below in combination with the drawings, including various details of the embodiments of the present disclosure to facilitate understanding, which should be considered as illustrative. Therefore, those of ordinary skill in the art should note that various changes and modifications may be made to the embodiments described herein, without departing from the scope and spirit of the present disclosure. Likewise, descriptions of well-known functions and structures are omitted in the following description for clarity and conciseness.

It should be noted that the terms “first”, “second”, etc. in the description and claims of the present disclosure and in the drawings, are used to distinguish between similar objects and not necessarily to describe a particular order or sequential order. It should be understood that data used in this way may be interchanged in appropriate cases, such that the embodiments of the present disclosure described herein may be implemented in a sequence other than those illustrated or described herein. In addition, the terms “include”, “have”, and any variations thereof are intended to cover non-exclusive inclusions, for example, processes, methods, systems, products, or devices that include a series of steps or units are not necessarily limited to those explicitly listed steps or units, but may include other steps or units not explicitly listed or inherent to these processes, methods, products, or devices.

### Embodiment One

The continuous development of network informatization and the image recognition processing technology makes optical character recognition (OCR) be widely concerned and applied in all walks of life such as education, finance, medical treatment, transportation and insurance. With the improvement of office electronization, documents originally saved in paper forms are gradually saved in image forms by electronic means such as scanners. To query or access specified recorded images, it is necessary to index images and image content data. To establish indexes, scanned images are generally classified through the OCR, and then recognized to obtain contents in the images.

A document image recognition solution of a mainstream image processing algorithm in the industry often needs to be implemented through complex image processing procedures. It is low in recognition accuracy and time-consuming to recognize a document image having poor quality or scanned document with noise (that is, a document image or scanned document having low contrast, uneven distribution of light and shade, blurred background, etc.) through the solution.

At present, when the OCR is used for document image recognition (for example, table recognition), a specific implementation process of document image recognition through the optical character recognition includes the following steps that binarization processing, tilt correction processing and image segmentation processing are conducted on a document image to extract a single character of the document image, and then an existing character recognition tool is called or a general neural network classifier is trained for character recognition.

Specifically, the document image is subjected to binarization processing that mainly includes: a global threshold method, a local threshold method, a region growing method, a waterline algorithm, a minimum description length method, a method based on a Markov random field, etc. And then a document image to be segmented is subjected to tilt correction processing that mainly includes: a method based on projection drawings, a method based on Hough transform, a nearest neighbor clustering method, a vectorization method, etc. A document image subjected to tilt correction is segmented, and the single character in the document image is extracted, and the existing character recognition tool is called or the general neural network classifier is trained for character recognition.

It may be seen that the methods need to be implemented through complex image processing procedures, and often have some drawbacks. For example, the global threshold method considers gray information of an image, but ignores spatial information in the image, uses a same gray threshold for all pixels, and is suitable for an ideal situation where brightness is uniform everywhere and a histogram of the image has obvious double peaks. When there is no obvious gray difference in the image or gray value ranges of various objects overlap greatly, it is usually difficult to obtain a satisfactory result. The local threshold method may overcome defects of uneven brightness distribution in the global threshold method but also has problems of window size setting, which include problems that an excessively small window is prone to line breakage and an excessively large window tends to lose due local details of the image. The projection method needs to compute a projection shape of each tilt angle. If tilt estimation accuracy is high, a computation amount of the method may be very large. The method is generally suitable for tilt correction of text documents. An effect of the method is poor for table correction with complex structures. When the nearest neighbor clustering method is time-consuming and has not satisfactory overall performance when having many adjacent components. A vectorization algorithm needs to directly process each pixel of raster images, and has a large amount of storage. Moreover, quality of a correction result, performance of an algorithm, and time and space cost of image processing depend greatly on selection of vector primitives. The Hough transform method is large in computation amount and time-consuming. It is difficult to determine a starting point and an end point of a straight line. The method is effective for plain text documents. For document images having complex structures with images and tables, the method cannot obtain a satisfactory result due to interference of images and tables. Therefore, application in concrete engineering practice is limited. In addition, it is low in recognition accuracy and time-consuming to recognize document images having poor quality or scanned documents with noise (that is, document images or scanned documents having low contrast, uneven distribution of light and shade, blurred background, etc.) through the method.

Based on the problems, an embodiment of the present disclosure provides a method for recognizing a document image. It should be noted that steps illustrated in flow diagrams of the accompanying drawings may be executable in a computer system such as a set of computer-executable instructions. Although a logical order is illustrated in the flow diagrams, in some cases, the steps shown or described may be executed in an order different from that herein.

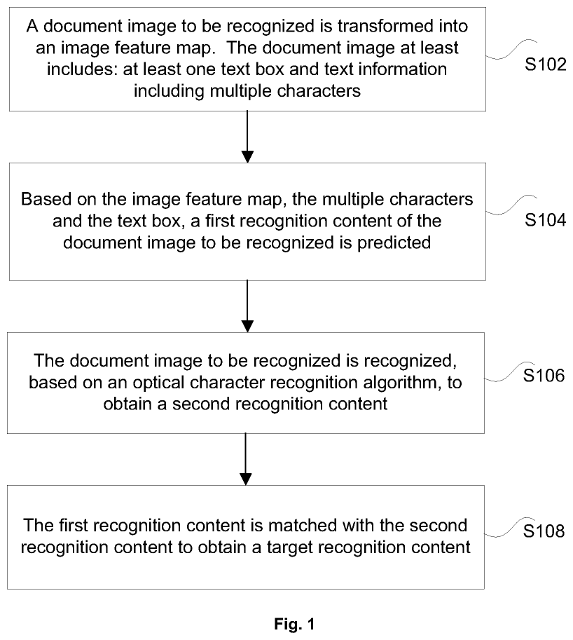

FIG. 1 is a flow diagram of a method for recognizing a document image according to a first embodiment of the present disclosure. As shown in FIG. 1, the method includes the following steps.

In step S102, a document image to be recognized is transformed into an image feature map. The document image at least includes: at least one text box and text information including multiple characters.

In step S104, based on the image feature map, the multiple characters and the text box, a first recognition content of the document image to be recognized is predicted.

In step S106, the document image to be recognized is recognized, based on an optical character recognition algorithm, to obtain a second recognition content.

In step S108, the first recognition content is matched with the second recognition content to obtain a target recognition content.

Optionally, the document image to be recognized is transformed into the image feature map by means of a convolutional neural network algorithm. That is, the document image to be recognized is input into an exchange neural network model to obtain the image feature map. The convolutional neural network algorithm may include, but is not limited to, ResNet, VGG, MobileNet and other algorithms.

Optionally, the first recognition content may include, but is not limited to, a text recognition content and position information of a text area in the document image recognized through a prediction method. The second recognition content may include, but is not limited to, a text recognition content and position information of a text area in the document image recognized by means of the OCR algorithm. An operation that the first recognition content is matched with the second recognition content may include, but is not limited to, the following step. The text recognition content and the position information of the text area in the first recognition content are matched with those in the second recognition content.

It should be noted that the method for recognizing a document image of the embodiment of the present disclosure is mainly applied to accurately recognize text information in a documents and/or chart. The document image at least includes: the at least one text box and the text information including the multiple characters.

In the embodiment of the present disclosure, the document image to be recognized is transformed into the image feature map, where the document image at least includes: the at least one text box and the text information including the multiple characters; based on the image feature map, the multiple characters and the text box, the first recognition content of the document image to be recognized is predicted; the optical character recognition algorithm is used for recognizing the document image to be recognized to obtain the second recognition content; and the first recognition content is matched with the second recognition content to obtain the target recognition content. Content information in the document image may be accurately recognized, recognition accuracy and efficiency of the document image may be improved, and a computation amount of an image recognition algorithm may be decreased, such that technical problems that it is low in recognition accuracy and large in computation amount of an algorithm to recognize a document image having poor quality though the method for recognizing a document image in related art are further solved.

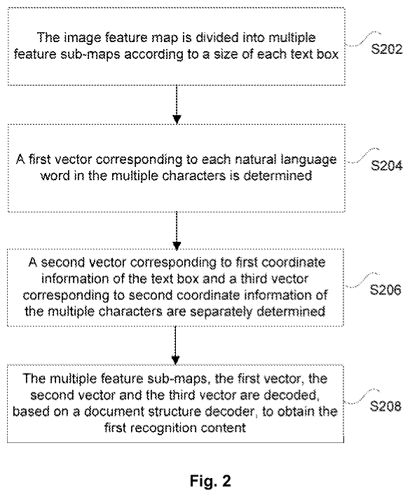

As an optional embodiment, FIG. 2 is a flow diagram of an optional method for recognizing a document image according to a first embodiment of the present disclosure. As shown in FIG. 2, an operation that based on the image feature map, the multiple characters and the text box, the first recognition content of the document image to be recognized is predicted includes the following steps.

In step S202, the image feature map is divided into multiple feature sub-maps according to a size of each text box.

In step S204, a first vector corresponding to each natural language word in the multiple characters is determined. Different natural language words of the multiple characters are transformed into vectors having equal and fixed lengths.

In step S206, a second vector corresponding to first coordinate information of the text box and a third vector corresponding to second coordinate information of the multiple characters are separately determined. Lengths of the second vector and the third vector are equal and fixed.

In step S208, the multiple feature sub-maps, the first vector, the second vector and the third vector are decoded, based on a document structure decoder, to obtain the first recognition content.

Optionally, the size of each text box is determined according to position information of the text box, and the image feature map is divided into the multiple feature sub-maps according to the size of each text box. Each text box corresponds to one feature sub-map, and a size of each of the feature sub-maps is consistent with that of a corresponding text box.

Optionally, after the image feature map (that is, a feature map of the entire document image to be recognized) is obtained, the image feature map is input into a region of interest (ROI) convolutional layer to obtain the feature sub-map corresponding to each text box in the document image to be recognized. The ROI convolutional layer is configured to extract at least one key feature (for example, at least one character feature) in each text box, and generate a feature sub-map having a consistent size with the corresponding text box.

Optionally, each character is input into a Word2Vec model to recognize natural language words in each character, and the natural language words in the multiple characters are transformed into the vectors having the equal and fixed lengths. That is, the first vector is obtained to process the multiple characters in batches and obtain the first recognition content.

Optionally, an operation of acquiring the first coordinate information of the text box and the second coordinate information of the multiple characters (that is, [x1, y1, x2, y2]) includes, but is not limited to, the following step. The first coordinate information and the second coordinate information are input into the Word2Vec model separately to transform the first coordinate information and the second coordinate information into the vectors (that is, the second vector and the third vector) having the equal and fixed lengths separately.

It should be noted that the multiple feature sub-maps, the first vector, the second vector and the third vector correspond to multiple different modal features. The document structure decoder decodes the multiple different modal features to obtain the first recognition content. In this way, text information features are highlighted, and the first recognition content in the document image to be recognized is more accurately recognized.

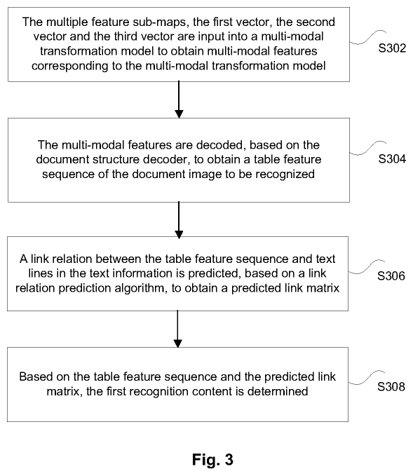

As an optional embodiment, FIG. 3 is a flow diagram of another optional method for recognizing a document image according to a first embodiment of the present disclosure. As shown in FIG. 3, an operation that the multiple feature sub-maps, the first vector, the second vector and the third vector are decoded, based on a document structure decoder, to obtain the first recognition content includes the following steps.

In step S302, the multiple feature sub-maps, the first vector, the second vector and the third vector are input into a multi-modal transformation model to obtain multi-modal features corresponding to the multi-modal transformation model.

In step S304, the multi-modal features are decoded, based on the document structure decoder, to obtain a table feature sequence of the document image to be recognized.

In step S306, a link relation between the table feature sequence and text lines in the text information is predicted, based on a link relation prediction algorithm, to obtain a predicted link matrix.

In step S308, based on the table feature sequence and the predicted link matrix, the first recognition content is determined.

Optionally, the multi-modal transformation model may be, but is not limited to, a Transformer model having a multi-layer self-attention network. The Transformer model may use an attention mechanism to improve a training speed of this model.

Optionally, the multi-modal transformation model is configured to transform and fusion information of different modalities into a same feature space to obtain the multi-modal features. That is, the multiple different modal features may be transformed into the same feature space by means of the multi-modal transformation model, and then the multiple different modal features are fused into one feature having multi-modal information (that is, the multi-modal features).

Optionally, the document structure decoder is used for decoding the multi-modal features to obtain the table feature sequence, such as “<thead><tr><td></td></tr></thead>” or other sequences, of the document image to be recognized.

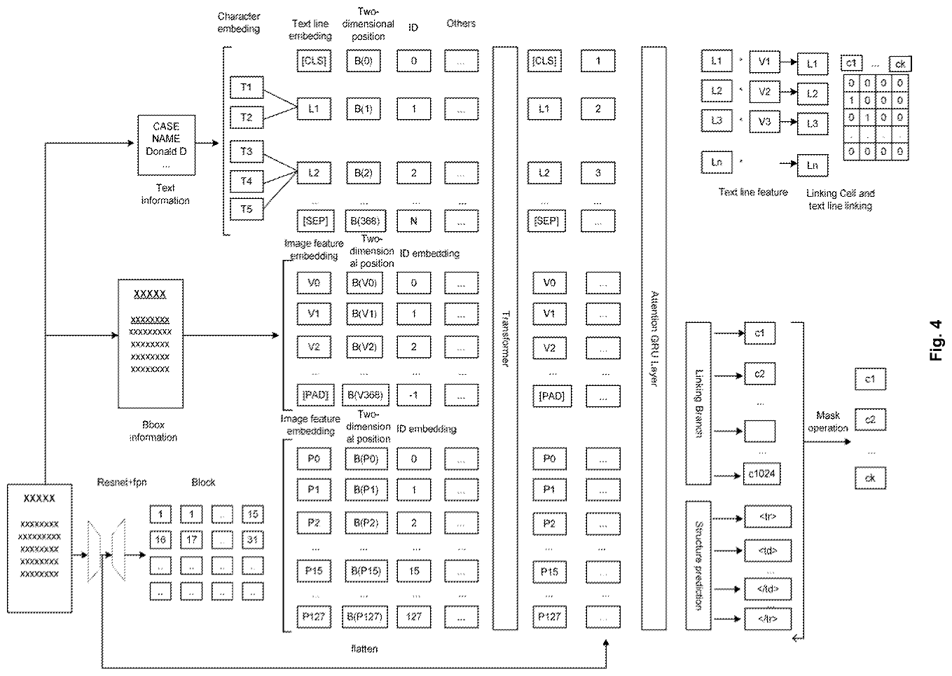

Optionally, the link relation prediction algorithm may be, but is not limited to, a linking algorithm. For example, as shown in FIG. 4, the link relation between the table feature sequence <td></td> and the text lines in the text information is predicted through a linking branch to obtain the predicted link matrix. The predicted link matrix is configured to determine the position information of the table feature sequence in the document image to be recognized.

It should be noted that the multiple feature sub-maps, the first vector, the second vector and the third vector correspond to the multiple different modal features. The multiple feature sub-maps, the first vector, the second vector and the third vector are input into the multi-modal transformation model to obtain the multi-modal features corresponding to the multi-modal transformation model. The document structure decoder is used for decoding the multi-modal features to obtain the table feature sequence of the document image to be recognized. The link relation prediction algorithm is used for predicting the link relation between the table feature sequence and the text lines in the text information to obtain the predicted link matrix. Based on the table feature sequence and the predicted link matrix, the first recognition content is determined. In this way, the text information features in the document image are highlighted, and the text information and the position information of the document image to be recognized are more accurately recognized.

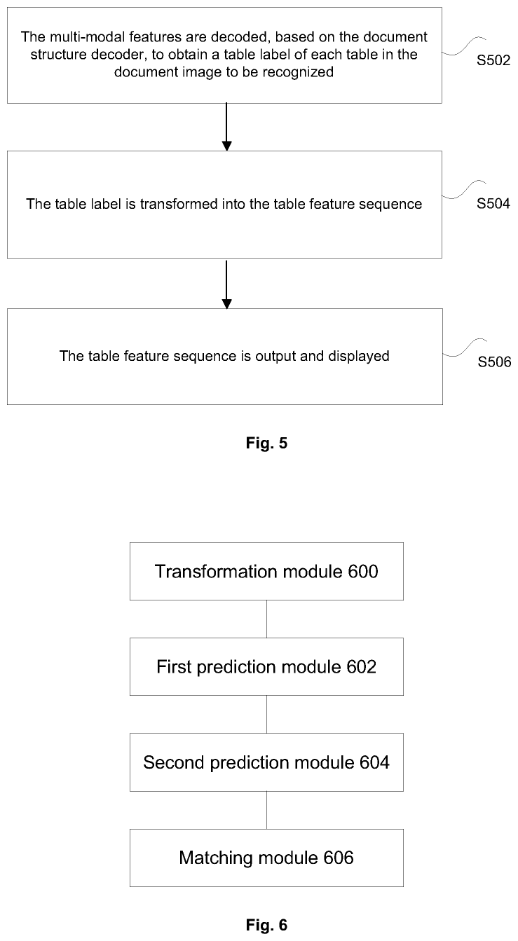

As an optional embodiment, FIG. 5 is a flow diagram of another optional method for recognizing a document image according to a first embodiment of the present disclosure. As shown in FIG. 5, an operation that the multi-modal features are decoded, based on the document structure decoder, to obtain the table feature sequence of the document image to be recognized includes the following steps.

In step S502, the multi-modal features are decoded, based on the document structure decoder, to obtain a table label of each table in the document image to be recognized.

In step S504, the table label is transformed into the table feature sequence.

In step S506, the table feature sequence is output and displayed.

Optionally, the multi-modal features output from the multi-modal transformation model are input into the document structure decoder. The document structure decoder may output the table label, such as <td>, of each table in the document image sequentially. The table label is transformed into the table feature sequence. Finally, a feature sequence of each table in the document image is output and displayed.

In an optional embodiment, an operation that a document image to be recognized is transformed into an image feature map includes the following steps.

The document image to be recognized is transformed, base on a convolutional neural network model, into the image feature map.

Optionally, the convolutional neural network model may include, but is not limited to, ResNet, VGG, MobileNet, or other convolutional neural network models.

It should be noted that the convolutional neural network model is used for transforming the document image to be recognized into the image feature map, such that recognition accuracy of the image feature map may be improved.

In an optional embodiment, an operation that the document image to be recognized is recognized, based on the optical character recognition algorithm, to obtain the second recognition content includes the following steps.

The document image to be recognized is recognized, based on the optical character recognition algorithm, to obtain first information of each text box and second information of each character.

Optionally, each of the first information and the second information includes: text information and coordinate information.

It should be noted that in the embodiment of the present disclosure, when the optical character recognition algorithm is used for recognizing the document image to be recognized to obtain the second recognition content, not only the text box in the document image to be recognized and the text information in the multiple characters but the position information corresponding to the text information are obtained. Through combining the text information and the position information, recognition accuracy of the text information in the document image may be improved.

It should be noted that the optional or example implementations of the embodiment may refer to the related description in an embodiment of a method for indicating information of a vehicle, which are not repeated herein. In the disclosed technical solution, obtaining, storage and application of personal information of a user all conform to provisions of relevant laws and regulations, and do not violate public order and good customs.

### Embodiment Two

An embodiment of the present disclosure further provides an apparatus for implementing the method recognizing a document image. FIG. 6 is a structural schematic diagram of an apparatus for recognizing a document image according to a second embodiment of the present disclosure. As shown in FIG. 6, an apparatus for detecting an obstacle includes: a transformation module 600, a first prediction module 602, a second prediction module 604 and a matching module 606.

The transformation module 600 is configured to transform a document image to be recognized into an image feature map. The document image at least includes: at least one text box and text information including multiple characters.

The first prediction module 602 is configured to predict, based on the image feature map, the multiple characters and the text box, a first recognition content of the document image to be recognized.

The second prediction module 604 is configured to recognize, based on an optical character recognition algorithm, the document image to be recognized to obtain a second recognition content.

The matching module 606 is configured to match the first recognition content with the second recognition content to obtain a target recognition content.

In the embodiment of the present disclosure, the transformation module 600 is configured to transform the document image to be recognized into the image feature map, where the document image at least comprises: at least one text box and text information including multiple characters; the first prediction module 602 is configured to predict, based on the image feature map, the multiple characters and the text box, the first recognition content of the document image to be recognized; the second prediction module 604 is configured to use the optical character recognition algorithm to recognize the document image to be recognized to obtain the second recognition content; and the matching module 606 is configured to match the first recognition content with the second recognition content to obtain the target recognition content. Feature extraction efficiency of obstacle images is improved, accuracy and efficiency of obstacle detection are enhanced, resource loss is reduced, and reliability of an obstacle detection technology in an automatic driving system is achieved. In this way, technical problems that it is low in recognition accuracy and large in computation amount of an algorithm to recognized a document image having poor quality through the method for recognizing a document image in related art are further solved.

It should be noted that the various modules may be implemented by software or hardware. In the case of hardware, the various modules may be implemented as follows: the various modules may be located in a same processor; or the various modules are separately located in different processors in any combination form.

It should be noted herein that the transformation module 600, the first prediction module 602, the second prediction module 604 and the matching module 606 correspond to step S102-step S108 in Embodiment One. Implementation examples and application scenes of the modules are consistent with those of the corresponding steps, which are not limited by what is disclosed in Embodiment One. It should be noted that the modules may be operated in a computer terminal as a part of the apparatus.

Optionally, the first prediction module further includes: a first division module configured to divide the image feature map into multiple feature sub-maps according to a size of each text box; a first determination module configured to determine a first vector corresponding to each natural language word in the multiple characters, where different natural language words of the multiple characters are transformed into vectors having equal and fixed lengths; a second determination module configured to separately determine a second vector corresponding to first coordinate information of the text box and a third vector corresponding to second coordinate information of the multiple characters, where lengths of the second vector and the third vector are equal and fixed; and a first decoding module configured to decode, based on a document structure decoder, the multiple feature sub-maps, the first vector, the second vector and the third vector to obtain the first recognition content.

Optionally, the first decoding module further includes: an inputting module configured to input the multiple feature sub-maps, the first vector, the second vector and the third vector into a multi-modal transformation model to obtain multi-modal features corresponding to the multi-modal transformation model, where the multi-modal transformation model is configured to transform and fusion information of different modalities into a same feature space to obtain the multi-modal features; a second decoding module configured to decode, based on the document structure decoder, the multi-modal features to obtain a table feature sequence of the document image to be recognized; a first prediction sub-module configured to predict, based on a link relation prediction algorithm, a link relation between the table feature sequence and text lines in the text information to obtain a predicted link matrix, where the predicted link matrix is configured to determine position information of the table feature sequence in the document image to be recognized; and a third determination module configured to determine, based on the table feature sequence and the predicted link matrix, the first recognition content.

Optionally, the second decoding module further includes: a third decoding module configured to decode, based on the document structure decoder, the multi-modal features to obtain a table label of each table in the document image to be recognized; a first transformation sub-module configured to transform the table label into the table feature sequence; and a display module configured to output and display the table feature sequence.

Optionally, the transformation module further includes: a second transformation sub-module configured to transform, base on a convolutional neural network model, the document image to be recognized into the image feature map.

Optionally, the transformation module further includes: a recognition module configured to recognize, based on the optical character recognition algorithm, the document image to be recognized to obtain first information of each text box and second information of each character, where each of the first information and the second information includes: text information and coordinate information.

It should be noted that the optional or preferred implementations of the embodiment may refer to the related description in Embodiment One, which is not repeated herein. In the disclosed technical solution, obtaining, storage and application of personal information of a user all conform to provisions of relevant laws and regulations, and do not violate public order and good customs.

### Embodiment Three

Embodiments of the present disclosure further provide an electronic device, a readable storage medium, a computer program product and a product for recognizing a document image, which includes the electronic device.

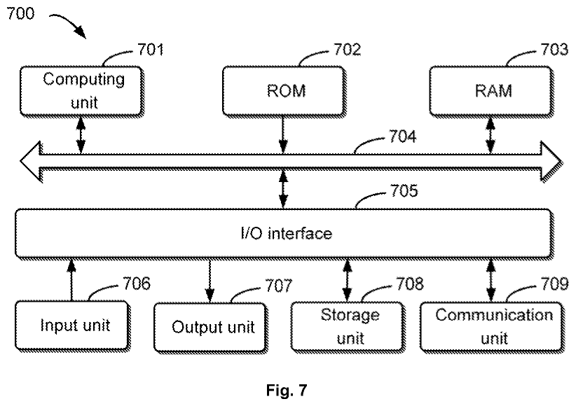

FIG. 7 shows a schematic block diagram of an example of an electronic device 700 that may be used to implement the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may also represent various forms of mobile apparatuses, such as a personal digital assistant, a cellular phone, a smart phone, a wearable device and other similar computing apparatuses. The components shown herein, as well as connections, relations and functions thereof are illustrative, and are not intended to limit implementation of the present disclosure described and/or claimed herein.

As shown in FIG. 7, the device 700 includes a computing unit 701, which may execute various appropriate actions and processing according to a computer program stored in a read-only memory (ROM) 702 or a computer program loaded from a storage unit 708 to a random access memory (RAM) 703. The RAM 703 may further store various programs and data required for operations of the device 700. The computing unit 701, the ROM 702, and the RAM 703 are connected with one another by means of a bus 704. An input/output (I/O) interface 705 is also connected with the bus 704.

Multiple components in the device 700 are connected with the I/O interface 705, which includes an input unit 706, such as a keyboard or a mouse; an output unit 707, such as various types of displays or speakers; a storage unit 708, such as a magnetic disk or an optical disk; and a communication unit 709, such as a network interface card, a modem, or a wireless communication transceiver. The communication unit 709 allows the device 700 to exchange information/data with other devices by means of a computer network such as the Internet and/or various telecommunication networks.

The computing unit 701 may be various general-purpose and/or special-purpose processing assemblies with processing and computing capabilities. Some examples of the computing unit 701 include, but are not limited to, a central processing unit (CPU), a graphics processing unit (GPU), various special-purpose artificial intelligence (AI) computing chips, various computing units that operate machine learning model algorithms, a digital signal processor (DSP), and any appropriate processor, controller, microcontroller, etc. The computing unit 701 executes the various methods and processing described above, such as a method for transforming a document image to be recognized into an image feature map. For example, in some embodiments, the method for transforming a document image to be recognized into an image feature map may be implemented as a computer software program, which is tangibly contained in a machine readable medium, such as the storage unit 708. In some embodiments, some or all of computer programs may be loaded and/or mounted onto the device 700 via the ROM 702 and/or the communication unit 709. When the computer program is loaded to the RAM 703 and executed by the computing unit 701, at least one step of the method for transforming a document image to be recognized into an image feature map described above may be executed. Alternatively, in other embodiments, the computing unit 701 may be configured, by any other suitable means (for example, by means of firmware), to execute the method for transforming a document image to be recognized into an image feature map.

Various implementations of systems and technologies described above may be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. The various implementations may include: an implementation in at least one computer program, which may be executed and/or interpreted on a programmable system including at least one programmable processor, the programmable processor may be a special-purpose or general-purpose programmable processor and capable of receiving/transmitting data and an instruction from/to a storage system, at least one input apparatus, and at least one output apparatus.

Program codes used for implementing the method of the present disclosure may be written in any combination of at least one programming language. The program codes may be provided for a general-purpose computer, a special-purpose computer, or a processor or controller of another programmable data processing apparatus, such that when the program codes are executed by the processor or controller, a function/operation specified in a flow diagram and/or block diagram may be implemented. The program codes may be executed entirely or partially on a machine, and, as a stand-alone software package, executed partially on a machine and partially on a remote machine, or executed entirely on a remote machine or server.

In the context of the present disclosure, the machine readable medium may be a tangible medium, which may contain or store a program for use by an instruction execution system, apparatus, or device, or for use in combination with the instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination thereof. More specific examples of the machine readable storage medium may include an electrical connection based on at least one wire, a portable computer disk, a hard disk, RAM, ROM, an erasable programmable read-only memory (EPROM or a flash memory), an optical fiber, a portable compact disk read-only memory (CD-ROM), an optical storage device, a magnetic storage device, or any suitable combination thereof.

To provide an interaction with a user, the system and technology described herein may be implemented on a computer having: a display apparatus (for example, a cathode ray tube (CRT) or a liquid crystal display (LCD) monitor) for displaying information to the user; and a keyboard and a pointing apparatus (for example, a mouse or a trackball), through which the user may provide input to the computer. Other kinds of apparatuses may also provide an interaction with the user. For example, a feedback provided to the user may be any form of sensory feedback (for example, visual feedback, auditory feedback, or tactile feedback); and input from the user may be received in any form (including acoustic input, voice input or tactile input).

The system and technology described herein may be implemented in a computing system (for example, as a data server) including a backend component, or a computing system (for example, an application server) including a middleware component, or a computing system (for example, a user computer with a graphical user interface or a web browser through which the user may interact with the implementation of the system and technology described herein) including a frontend component, or a computing system including any combination of the backend component, the middleware component, or the frontend component. The components of the system may be connected with each other through digital data communication (for example, a communication network) in any form or medium. Examples of the communication network include: a local area network (LAN), a wide area network (WAN) and the Internet.

A computer system may include a client and a server. The client and the server are generally far away from each other and usually interact with each other through a communication network. A relation between the client and the server is generated by computer programs operating on respective computers and having a client-server relation with each other. The server may be a cloud server or a server in a distributed system, or a server combined with a blockchain.

It should be understood that steps may be reordered, added, or deleted on the basis of various forms of procedures shown above. For example, the steps recorded in the present disclosure may be executed in parallel, in order, or in a different order, provided that the desired result of the technical solutions disclosed in the present disclosure may be achieved, which is not limited herein.

The specific embodiments do not limit the protection scope of the present disclosure. It will be apparent to those skilled in the art that various modifications, combinations, sub-combinations and substitutions are possible, depending on design requirements and other factors. Any modifications, equivalent substitutions, improvements, etc. within the spirit and principles of the present disclosure are intended to fall within the protection scope of the present disclosure.

What is claimed is:

1. A method for recognizing a document image, comprising:
transforming a document image to be recognized into an image feature map, wherein the document image at least comprises at least one text box and text information comprising a plurality of characters;
predicting, based on the image feature map, the plurality of characters and the text box, a first recognition content of the document image to be recognized;
recognizing, based on an optical character recognition algorithm, the document image to be recognized to obtain a second recognition content; and
matching the first recognition content with the second recognition content to obtain a target recognition content.

2. The method as claimed in claim 1, wherein predicting, based on the image feature map, the plurality of characters and the text box, the first recognition content of the document image to be recognized comprises:
dividing the image feature map into a plurality of feature sub-maps according to a size of each text box;
determining a first vector corresponding to each natural language word in the plurality of characters, wherein different natural language words of the plurality of characters are transformed into vectors having equal and fixed lengths;
separately determining a second vector corresponding to first coordinate information of the text box and a third vector corresponding to second coordinate information of the plurality of characters, wherein lengths of the second vector and the third vector are equal and fixed; and
decoding, based on a document structure decoder, the plurality of feature sub-maps, the first vector, the second vector and the third vector to obtain the first recognition content.

3. The method as claimed in claim 2, wherein decoding, based on a document structure decoder, the plurality of feature sub-maps, the first vector, the second vector and the third vector to obtain the first recognition content comprises:
inputting the plurality of feature sub-maps, the first vector, the second vector and the third vector into a multi-modal transformation model to obtain multi-modal features corresponding to the multi-modal transformation model, wherein the multi-modal transformation model is configured to transform and fusion information of different modalities into a same feature space to obtain the multi-modal features;
decoding, based on the document structure decoder, the multi-modal features to obtain a table feature sequence of the document image to be recognized;
predicting, based on a link relation prediction algorithm, a link relation between the table feature sequence and text lines in the text information to obtain a predicted link matrix, wherein the predicted link matrix is configured to determine position information of the table feature sequence in the document image to be recognized; and
determining, based on the table feature sequence and the predicted link matrix, the first recognition content.

4. The method as claimed in claim 3, wherein decoding, based on the document structure decoder, the multi-modal features to obtain the table feature sequence of the document image to be recognized comprises:
decoding, based on the document structure decoder, the multi-modal features to obtain a table label of each table in the document image to be recognized;
transforming the table label into the table feature sequence; and
outputting and displaying the table feature sequence.

5. The method as claimed in claim 1, wherein transforming the document image to be recognized into the image feature map comprises:
transforming, base on a convolutional neural network model, the document image to be recognized into the image feature map.

6. The method as claimed in claim 1, wherein recognizing, based on the optical character recognition algorithm, the document image to be recognized to obtain the second recognition content comprises:
recognizing, based on the optical character recognition algorithm, the document image to be recognized to obtain first information of each text box and second information of each character, wherein each of the first information and the second information comprises: text information and coordinate information.

7. The method as claimed in claim 1, wherein the first recognition content comprises a text recognition content and position information of a text area in the document image recognized through a prediction method.

8. The method as claimed in claim 1, wherein the second recognition content comprises a text recognition content and position information of a text area in the document image recognized by means of the optical character recognition algorithm.

9. The method as claimed in claim 1, wherein matching the first recognition content with the second recognition content to obtain the target recognition content comprises:
matching a text recognition content and position information of a text area in the first recognition content with a text recognition content and position information of a text area in the second recognition content to obtain the target recognition content.

10. The method as claimed in claim 2, wherein the size of each text box is determined according to position information of the text box.

11. The method as claimed in claim 2, wherein each text box corresponds to one feature sub-map, and a size of each of the feature sub-maps is consistent with a size of a corresponding text box.

12. The method as claimed in claim 2, wherein dividing the image feature map into the plurality of feature sub-maps according to the size of each text box comprises:
inputting the image feature map into a region of interest convolutional layer to obtain the feature sub-map corresponding to each text box in the document image to be recognized according to the size of each text box.

13. The method as claimed in claim 12, wherein the region of interest convolutional layer is used for extracting at least one key feature in each text box, and generating a feature sub-map having a consistent size with the corresponding text box.

14. The method as claimed in claim 13, wherein the at least one key feature is at least one character feature.

15. The method as claimed in claim 2, wherein determining the first vector corresponding to each natural language word in the plurality of characters comprises:
inputting each character into a Word2Vec model to recognize natural language words in each character, and transforming the natural language words in the multiple characters into the first vector corresponding to each natural language word.

16. The method as claimed in claim 2, wherein determining the second vector corresponding to first coordinate information of the text box comprises:
inputting the first coordinate information into a Word2Vec model to transform the first coordinate information into the second vector.

17. The method as claimed in claim 2, wherein determining the third vector corresponding to second coordinate information of the plurality of characters comprises:
inputting the second coordinate information into a Word2Vec model to transform the second coordinate information into the third vector.

18. The method as claimed in claim 3, wherein the multi-modal transformation model is a Transformer model having a multi-layer self-attention network.

19. An electronic device, comprising:
at least one processor; and
a memory communicatively connected with the at least one processor, wherein the memory is configured to store at least one instruction executable by the at least one processor, and the at least one instruction enables the at least one processor to execute the following steps:
transforming a document image to be recognized into an image feature map, wherein the document image at least comprises at least one text box and text information comprising a plurality of characters;
predicting, based on the image feature map, the plurality of characters and the text box, a first recognition content of the document image to be recognized;
recognizing, based on an optical character recognition algorithm, the document image to be recognized to obtain a second recognition content; and
matching the first recognition content with the second recognition content to obtain a target recognition content.

20. A non-transitory computer readable storage medium storing at least one computer instruction, wherein the at least one computer instruction is configured to enable a computer to execute the following steps:
transforming a document image to be recognized into an image feature map, wherein the document image at least comprises at least one text box and text information comprising a plurality of characters;
predicting, based on the image feature map, the plurality of characters and the text box, a first recognition content of the document image to be recognized;
recognizing, based on an optical character recognition algorithm, the document image to be recognized to obtain a second recognition content; and
matching the first recognition content with the second recognition content to obtain a target recognition content.
